(19) United States
(12) Patent Application Publication
(10) Pub. No.: US 2004/0242831 A1
(43) Pub. Date: Dec. 2, 2004

(54) Enzyme catalyzed polyesters and polyol polymers

(76) Inventors: Dong Tian, Lancaster, PA (US); Jeffrey S. Ross, Lancaster, PA (US); Courtney R. Price, Lancaster, PA (US)

Correspondence Address: ARMSTRONG WORLD INDUSTRIES, INC., LEGAL DEPARTMENT, P. O. BOX 3001, LANCASTER, PA, 17604-3001, US

(21) Appl. No.: 10/448,794

(22) Filed: May 30, 2003

(51) Int. Cl. C08G 18/00

(52) U.S. Cl. 528/44; 528/425; 428/423.1

(57) ABSTRACT

Methods for synthesizing saturated and unsaturated polyol polymers are disclosed. In one embodiment, the method involves the ring-opening polymerization of lactones, lactides and/or glycolides using hydroxy moiety-containing polymerization initiators, which initiators can include one or more double bond-containing moieties such as (meth)acrylates. The ring-opening polymerization is catalyzed using a lipase enzyme. In another embodiment, the polyol polymers are prepared by the esterification of a di- or polycarboxylic acid with a polyhydric alcohol or a polyhydric alcohol modified to include one or more (meth)acrylate moieties, using an enzymatic catalyst, advantageously avoiding the use of an acidic or heavy metal catalyst. The polyol polymers can be used to prepare urethanes or urethane acrylates, and the urethanes or urethane acrylates used in coating compositions, for example, to provide a coating to surface coverings such as floor, wall and ceiling coverings. The polyol polymers and/or urethane (meth)acrylates can also be used to prepare other articles of manufacture, such as food wraps, children's toys and the like.

### FIELD OF THE INVENTION

This invention is generally in the area of the preparation of polyol polymers by enzyme catalyst ring opening of lactones, as well as enzyme catalyzation of acrylated polyol polymers, and coating compositions including polyol polymers and/or acrylated polyol polymers prepared by enzyme catalyst, providing stable coatings that offer several advantages relative to the use of heavy metal or strong acid catalysts to prepare the polyol polymers.

### BACKGROUND OF THE INVENTION

Currently, heavy metal or strong acid catalysts are used to prepare polyol polymers used in the coatings industry. For example, U.S. Pat. No. 3,169,945 reported that saturated polylactone polyols can be prepared by the reaction between lactone and monofunctional alcohol or polyfunctional alcohol catalyzed by metals, such as lithium, calcium, cobalt, and the like, as well as the alkoxides thereof. Additional suitable catalysts are, by way of example, the carbonates of alkali- and alkaline earth metal, zinc borate, lead borate, zinc oxide, lead silicate, lead arsenate, lead carbonate, antimony trioxide, germanium dioxide, cerium trioxide, cobaltous acetate, aluminum isopropoxide as well as organic titanium compounds.

U.S. Pat. No. 3,655,631 reported that delta, epsilon, and zeta lactones were polymerized in the presence of strong organic acid catalysts, such as halogen-activated carboxylic acids or sulfonic acids, and compounds of the formula L-CH₂OH as an initiator wherein L contains ethylenic-unsaturation. The resulting terminally unsaturated polylactone were purportedly suitable for co-polymerization with ethylenically unsaturated monomers.

U.S. Pat. No. 3,700,643 and RE29,131 reported that (meth)acrylated-capped polycaprolactone can be formed by reacting polycaprolactone polyols, which contain at least one free hydroxyl moiety, an organic isocyanate and hydroxyalkyl (meth)acrylate. These patents also disclose that polycaprolactone polyols will react with (meth)acrylic acid or hydroxyalkyl (meth)acrylate to produce a (meth)acrylated-capped polycaprolactone derivative.

U.S. Pat. No. 4,791,189 teaches the cationic ring-opening polymerization of a lactone in the presence of an alcohol having a vinyl head moiety, using an oxonium salt or boron trifluoride etherate as the cationic ring-opening catalyst, to form a polylactone macromonomer with a vinyl functional head moiety at one end and a hydroxyl (OH) moiety at the other.

U.S. Pat. No. 4,916,254, teaches using stannous halide as a catalyst to react epsilon-caprolactone and a hydroxyalkyl (meth)acrylate to produce polycaprolactone-modified hydroxyalkyl (meth)acrylate.

U.S. Pat. No. 5,731,406, teaches using phosphoric acid as a catalyst for preparing a macromonomer by reacting a lactone and a hydroxyalkyl (meth)acrylate.

U.S. Pat. No. 4,683,287 (6), teaches using stannous octanoate, dibutyltin dilaurate, tetra-isopropyl titanate, butyl titanate, and mixtures thereof as catalysts for preparing macromonomers by reacting a lactone and a hydroxyalkyl (meth)acrylate. These heavy metal and strong acid catalysts have given rise to some environmental issues, as well as stability issues of the resulting coatings due to the presence of catalyst residues.

H. Uyama and S. Kobayashi reported (“H. Uyama and S. Kobayashi, Chemistry Letters 1149-1150 (1993) and Polymer Preprints 35(1):444-445 (1994)) the polymerization of epsilon-caprolactone and delta-valerolactone using lipase enzymes derived from Pseudomonas fluorescence, Candida cylindracea and porcine pancreas. The polymerizations were conducted in bulk for 10 days. Among these three lipase enzymatic catalysts, Pseudomonas fluorescence lipase gave the highest monomer conversion of 92% and molecular weight of 7.7×10³ at 75° C. The study of the structure of one of the Pseudomonas fluorescence lipase-catalyzed polymers showed that the terminal moieties were carboxylic acid and hydroxyl, respectively. The mechanisms proposed for the enzymatic ring-opening polymerization of lactones are as follows. The first step was the ring-opening of lactone with water, perhaps contained in the enzyme, to afford beta-hydroxycarboxylic acid. Then, there were two possible routes of propagation: one is the esterification of two molecules of the hydroxycarboxylic acid and the other is the transesterification of the beta-hydroxycarboxylic acid with the lactone. The two reactions may take place competitively.

R. A. Gross and co-workers reported (Gross et al., Macromolecules 28, p. 73-78, 1995) the effect of the reaction water content and the monomer/butanol ratio on the molecular weight and chain end moiety structure of the polymerization of epsilon-caprolactone using porcine pancreatic lipase as catalysts. They found that keeping the water content at 0.29 mmol and increasing the epsilon-caprolactone/butanol ratio from 15/1 up to where no butanol was added showed only modest increase in product molecular weight. This indicated that the water in polymerization was active in chain initiation. Variations in the butanol/monomer ratio (from 0.067 to 0, or 1/15 to 0/15) at constant water concentration resulted in PCL chains with from 0.65 to 0 mol fraction of butyl ester and from 0.33 to 0.86 mol fraction of carboxylic acid chain end moieties.

R. A. Gross and co-workers reported (“In-vitro Enzyme Catalyzed Polymer Synthesis,” Chemical Reviews, 101(7): 2097-2124 (2001)) various lipase-catalyzed condensation polymerizations. They reported examples that illustrate: i) polymerization of bis(2,2,2-trichloroethyl)trans-3,4-epoxyadipate and 1,4-butanediol, resulting in enantioselective propagation steps and the generation of an optically active polymer from racemic monomer, ii) the solventless co-polymerization of divinyl adipate and 1,4-butanediol, iii) the polymerization of dicarboxylic acid divinyl esters of isophthalic acid, terephthalic acid, and p-phenylene diacetic acid with glycols.

A limitation of using acidic and/or heavy metal catalysts is that the residues of these catalysts can accelerate the decomposition of the resulting polymers. It would be advantageous to provide methods for generating polyol polymers, including acrylated polyol polymers, using enzymatic catalysts, and providing coating compositions including these acrylated polyol polymers or components derived from these acrylated polyol polymers that are essentially free from strong acid or heavy metal residues. The present invention provides such methods and compositions.

### SUMMARY OF THE INVENTION

Methods for synthesizing saturated and unsaturated polyol polymers are disclosed. The methods are environmentally-friendly and provide environmentally-friendly compositions that do not contain heavy metals or strong acid catalyst residues such as are present when heavy metals and/or strong acids are used as catalysts to manufacture these materials.

In one embodiment, the method involves the ring-opening polymerization of lactones, lactides and/or glycolides using hydroxy moiety-containing polymerization initiators, which initiators can include one or more double bond-containing moieties such as (meth)acrylates. As used herein, “(meth)acrylate” means “acrylate, methacrylate or a combination of acrylate and methacrylate.” The ring-opening polymerization is catalyzed using a lipase enzyme.

In another embodiment, the polyol polymers are prepared by the esterification of a di- or polycarboxylic acid with a polyhydric alcohol or a polyhydric alcohol modified to include one or more acrylate moieties, using an enzymatic catalyst, advantageously avoiding the use of an acidic or heavy metal catalyst. The resulting polyester polyol can be acrylated if desired.

Polyol polymer and acrylated polyol polymer-containing compositions that are essentially free of acidic and heavy metal catalyst residues, and which can contain a lipase and/or lipase residues, are also disclosed.

Urethane acrylates prepared using these polyol polymers and/or acrylated polyol polymers and methods of preparing the urethane acrylates are also disclosed. The urethane acrylates are prepared by reacting one or more hydroxy moieties on the polyol polymers with one or more isocyanate moieties on a di- and/or polyisocyanate to form urethane linkages. In one embodiment, the polyol polymer includes at least one (meth)acrylate moiety. In another embodiment, at least one isocyanate moiety in the polyisocyanate is reacted with a hydroxy moiety on a compound that includes at least one hydroxy moiety and at least one (meth)acrylate moiety. In either embodiment, the resulting urethane includes at least one (meth)acrylate moiety. When the polyol polymer is prepared using a lipase catalyst rather than an acidic or heavy metal catalyst, the urethane acrylate is essentially free of acidic or heavy metal catalyst residues.

Coating compositions including the polyol polymers and acrylated polyol polymers and/or urethanes and urethane acrylates prepared using these polyol polymers or acrylated polyol polymers are also disclosed. The coating compositions can be 100% solids coating compositions, water-based coating compositions or solvent-based coating compositions. The compositions can include flatting agents, reactive diluents, photoinitiators, and/or other components suitable for use in coating compositions. In one embodiment, the coatings prepared using the coating compositions are essentially free of acidic and/or heavy metal catalyst residues. The coating compositions can be used to coat surface coverings, such as floor, wall, and ceiling coverings, and such coated floor, wall and ceiling coverings are also disclosed. The “catalyst free” coating compositions can also be water-based, solvent-based and 100% solids UV-curable coating compositions, and can be used to prepare high-performance coatings. The coatings prepared from these coating compositions have improved stability relative to coatings prepared using polyol polymers, acrylated polyol polymers, urethanes or urethane acrylates prepared using heavy metal and/or acid catalysts and that include residues of these catalysts.

In addition to coatings, the polyol polymers and acrylated polyol polymers and/or urethanes and urethane acrylates prepared using these polyol polymers or acrylated polyol polymers, can be used as one or more components in the preparation of various articles of manufacture, such as food wraps, children's toys and the like. Additionally, these polyol polymers can be used to prepare a variety of urethane products that find application in foams, biomedical materials, thermoplastic polyurethanes, and the like.

### DETAILED DESCRIPTION OF THE INVENTION

The polyol polymers and acrylated polyol polymers, methods for preparing these compounds, urethanes and urethane acrylates prepared using these compounds, coating compositions including these compounds and/or urethanes and urethane acrylates prepared using these compounds, and surface coverings and other articles of manufacture prepared from these compounds and compositions, are discussed in more detail below.

The polyol compositions described herein are essentially free of residual acid and/or heavy metals (i.e., the chemistry is “green chemistry” and is environmental-friendly), relative to those prepared using heavy metal and/or acid catalysts. Further, coatings that include these compounds have relatively improved long-term stability, including hydrolysis stability, color stability and light and heat stability.

Using enzymatic catalysts, the method can be performed at lower temperatures than when heavy metals and/or strong acid catalysts are used. For example, the processing temperature using the enzymatic catalysts is in the range of 70-90° C., whereas a temperature range of 120-160° C. is used in connection with acid and/or heavy metal catalysts, with similar reaction times. This results in significant energy savings, and can also result in less color in the final products.

The resulting method provides saturated and unsaturated macro monomers. The saturated and unsaturated macro monomers have a wide application in the coating market. Also, polylactone polyols are one of the major components in the polyurethane market (including thermoplastic polyurethane). For example, polylactone polyols can be reacted with isocyanates and hydroxy-acrylates to form the urethane acrylates in several commercial coating formulations, including Armstrong World Industries' radiation curable Duracote™ coating formulations. In particular, the polyols can be used with a hydroxyacrylate such as Union Carbide's Tone M100 and an isocyanate such as BASF's Desmodur® 3300.

Finally, the ability to avoid metal or acid catalyst residues in UV-curable compositions provides certain additional advantages, such as relatively improved heat and light stability when compared to similar compositions including such residues. Although catalyst residue is not known to pose significant health or safety risks with finished floor coverings or polyurethane coatings, the avoidance of such residues is advantageous when the materials are used in food packaging, children's toys, medical and biomedical implants and the like. The compositions described herein are essentially free of acidic or heavy metal catalyst residues (i.e., include less than about 50 ppm of these residues).

I. Production of Polyol Polymers

In one embodiment, the polylactone polyol monomers are prepared via the ring-opening polymerization of lactones, lactide and/or glycolide. This ring-opening reaction is initiated by a hydroxy moiety-containing polymerization initiator (typically a monofunctional alcohol or polyfunctional alcohol) and catalyzed via a lipase enzyme.

The resulting polylactone polyols typically have a weight average molecular weight in the range of about 146 to about 7000, although molecular weights outside these ranges are within the scope of this invention. The ratio of initiator and the lactone monomer is typically from 1 to 0.067 (1/1 to 1/15) when the hydroxy moiety-containing polymerization initiator is a monofunctional alcohol. The ratio of the initiator and the lactone monomer is typically from 1 to 0.0167 (1/1 to 1/60) when the hydroxy moiety-containing polymerization initiator is a polyfunctional alcohol.

In another embodiment, di- and/or polycarboxylic acids are reacted with compounds including more than one hydroxy moiety to form polyester polyols. The esterification reaction is catalyzed by a lipase.

The polyol polymers can include one or more (meth)acrylate moieties, which can be provided by either end-capping the polyols with (meth)acrylate moieties, ideally using a lipase enzyme as the catalyst, or by providing a (meth)acrylate moiety in the hydroxy moiety-containing compounds used in the ring-opening polymerization or the esterification reaction.

The individual reaction components are described in detail below.

A. Lactones, Hydroxy-Acids Such as Lactide and Glycolide, and Di- and Polycarboxylic Acids

Any lactone that is susceptible to enzyme-catalyzed ring-opening polymerization can be used in the method described herein. Examples include epsilon-caprolactone, valerolactone and other 4-alkyl butanolides. Additional representative lactones include those described in U.S. Pat. No. 3,655,631, the contents of which are hereby incorporated by reference in its entirety.

Cyclic esters of hydroxy acids can also be used in addition to, or in place of, the lactones. Representative examples include lactide, glycolide and the like, as well as lactic acid and glycolic acid.

Di- and polycarboxylic acids (also referred to herein as dibasic and polybasic carboxylic acids) can also be formed into polyester polyols by reaction with compounds including two or more hydroxy moieties (i.e., di- and/or polyols). Examples of dibasic and polybasic carboxylic acids that can be used to form the polyol polymers include, but are not limited to, phthalic acid, phthalic anhydride, isophthalic and terephthalic acid, maleic acid, maleic anhydride, succinic acid, succinic anhydride, adipic, trimellitic acid, trimellitic anhydride, pimelic, suberic, azelaic and sebacic acid, fumaric and citraconic acid, glutaric acid, glutaric anhydride, pyromellitic acid and pyromellitic anhydride, tetrahydrophthalic acid, tetrahydrophthalic anhydride.

B. Initiators

The ring-opening polymerization reaction is essentially a trans-esterification reaction, where the lactone (or lactide or glycolide) is a cyclic ester. To function as an initiator, a compound has to have one hydroxy moiety capable of opening the first lactone moiety, which in turn provides a free hydroxyl moiety that can react with the next lactone moiety, until the polymerization reaction is complete.

When initiators with more than one hydroxy moiety capable of initiating the ring-opening polymerization reaction are used, more than one polymer chain can be formed from the central initiator. Examples of initiators with more than one hydroxy moiety capable of initiating the ring-opening polymerization reaction include polyhydric alcohols such as sorbitol, glycerol and the like.

An acrylate moiety can be incorporated into the polyol polymer at this stage by using a hydroxy moiety-containing polymerization initiator that includes an acrylate moiety. For example, monofunctional alcohols and/or polyflnctional alcohols, such as diol/triol/tetraol, hydroxyalkyl (meth)acrylate, or (R¹)ₐR(OH)_{b} can be used as initiators for the ring-opening polymerization of the lactones to prepare saturated/unsaturated polylactone polyols. In addition to acrylate moieties, other double bond-containing moieties can be used, for example, allyl, alkynyl, vinyl, vinylidene, vinyl ether and the like.

In the formula (R¹)ₐR(OH)_{b}, a+b≧2, b is at least 1, R¹ is a double bond-containing moiety such as allyl, vinyl, vinylidene, vinyl ether, acrylate, and the like, and R is an alkyl, aryl, aralkyl, alkaryl, ether or ester moiety, including substituted versions thereof. The substituents can be any functional moiety that does not negatively effect the desired enzyme-catalyzed reaction. Examples of suitable substituents include halo, thio, nitrile, nitro, ester, ether, amide, ketone, acetal, silyl, and phosphorous-containing moieties.

R also can be a polymer, including polymers with a plurality of functional moieties. Examples of hydroxyl moiety-containing acrylate compounds include, but are not limited to, 2-hydroxyethyl acrylate, 2-hydroxypropyl acrylate, pentaerythritol triacrylate, and dipentaerythritol pentacrylate.

As used herein, alkyl refers to a straight chain, branched or cyclic alkyl. Heterocyclic moieties can be present provided they do not adversely affect the enzymatic catalysis.

As used herein, alkenyl and alkynyl refer to straight chain, branched or cyclic alkenes and alkynes.

As used herein, aryl refers to a C₆₋₁₀ monocyclic or polycyclic aromatic moiety, including, but not limited to, phenyl, biphenyl, and napthalenyl. Heteroaryl and heterocyclic moieties can be present provided they do not adversely affect the enzymatic catalysis

As used herein, aralkyl refers to an aryl moiety that includes one or more alkyl moieties, where the linkage is directly on the aryl moiety, and alkaryl refers to an alkyl moiety that includes one or more aryl moieties, where the linkage is directly on the alkyl moiety.

C. Enzymatic Catalysts

Examples of suitable enzymatic lipase catalysts (lipases) include, but are not limited to, porcine pancreatic lipase (PPL), Candida cylindracea lipase (CCL), Pseudomonas fluorescence lipase (PFL), Rhizopus javanicuc lipase (RJL), Rhizopus delemar lipase (RDL) and Novozyme 435™.

D. Solvent Systems

The reaction can be performed in any suitable solvent system. The solvent ideally does not include a significant amount of water beyond that required for the enzyme to function, since the water can compete with the polyol initiators to initiate polymerization of the lactones. The solvent ideally does not include a significant amount of alcohols other than the polyol initiators for the same reason. In those embodiments where the final product is a liquid at the reaction temperature, the reaction can be run neat (i.e., without added solvent).

Ionic liquids and/or supercritical fluid carbon dioxide have both been used as solvents for enzymatic reactions, and can be used in the methods described herein. Organic solvents, such as hexane, heptane, toluene, xylene and the like, can also be used.

E. Reaction Conditions

As discussed above, the method involves producing a saturated/unsaturated polylactone polyol macromonomer by reacting a lactone and an initiator such as a diol/triol/tetraol, a hydroxyalkyl (meth)acrylate and/or a compound of the Formula (R¹)ₐR(OH)_{b} in the presence of a lipase enzyme catalyst. The ring-opening polymerization reaction generally occurs at standard pressure, and at a temperature less than about 120° C., although higher temperatures can be used. The reaction is typically complete in less than about 24 hours. However, the temperature and time for reaction can be dependent upon the particular catalyst used.

II. Acrylation of Polyols.

In the embodiment described above, the polyol polymers are produced with initiators that can but need not include acrylate or other UV-curable moieties. A second way to incorporate such moieties using the lipase catalysts is to first obtain a polyol polymer, and then acrylate one or more hydroxyl moieties on the polyol polymer using (meth)acrylic acid using the lipase catalyst. Advantageously, the polyol polymer that is used is also prepared using a lipase, so that it does not include any acidic or heavy metal catalyst residues.

Polyol Polymers

The polyol polymers described herein include at least one or two free hydroxyl moieties per molecule, and include polyesters with or without ether moieties, and polyethers with or without ester moieties. The hydroxyl-containing polyesters can be formed by esterifying dibasic or polybasic carboxylic acids with dihydric or polyhydric alcohols. In general, the carboxylic acid component used to esterify the hydroxyl-containing polyesters can be dibasic, tribasic and/or tetrabasic, aliphatic and/or aromatic C₃₋₃₆ carboxylic acids, and their esters and anhydrides. The polyol polymers can be identical to those prepared as described above by ring-opening polymerization of lactones, provided they include at least one or two free hydroxyl moieties per molecule.

Examples of dihydric and polyhydric alcohols suitable as starting materials for preparing polyesters include dihydric to hexahydric alcohols. Representative diols include, but are not limited to, ethylene glycol, propylene glycol, 1,4-butanediol, 2-ethyl-1,4-butanediol, 1,5-pentanediol, 2-methyl-1,5-pentanediol, 1,6-hexanediol, dimethylolcyclohexane, neopentyl glycol, triols such as trimethylolethane, trimethylolbutane, trimethylolpropane, glycol, tetraols such as pentaerythritol and ditrimethylolpropane, hexols, such as erythritol and sorbitol. Other polyesterols that can be used include polylactonediols, -triols and -tetraols, as mentioned above. The polyols also can be the alkoxylates of the above-mentioned dihydric and/or polyhydric alcohols, including ethoxylated, propoxylated and mixed ethoxylated and propoxylated dihydric to hexahydric alcohols and polyesterols. The degree of alkoxylation is generally from 1 to 300, preferably from 2 to 150. Further, the polyols can be polyalkylene glycols and the polyaddition polymers of cyclic ethers, such as polytetrahydrofuran. Examples of polyalkylene glycols include, but are not limited to, polyethylene glycol, polypropylene glycol and polyepichlorohydrins.

Other polyol polymers that can be used include copolymers comprising in copolymerized form at least one of the above mentioned monomeric, oligomeric and/or polymeric components. Polyesters of the above-mentioned dibasic and/or polybasic carboxylic acids and alcohols with terminal carboxyls or hydroxyls, and polyetherols, such as the above mentioned alkoxylates, polyalkylene glycols and polymers of cyclic ethers, also can be used. Furthermore, the polyols can be mono- or multi-functional alcohols, such as diols, triols, tetraols, hexols, and the like. Representative examples include, but are not limited to, tridecyl alcohol, iso-octanol, ethylene glycol, propylene glycol, 1,4-butanediol, 2-ethyl-1,4-butanediol, 1,5-pentanediol, 2-methyl-1,5-pentanediol, 1,6-hexanediol, dimethylolcyclohexane, neopentyl glycol, trimethylolethane, trimethylolbutane, trimethylolpropane, glycol, pentaerythritol, ditrimethylolpropane, erythritol and sorbitol.

III. Urethanes and Urethane Acrylates Prepared Using Saturated and Unsaturated Polyol Polymers

The saturated and unsaturated polyol polymers described herein can be used to prepare urethanes and urethane acrylates. Where the polyol polymers are saturated, the reaction of a di- or polyisocyanate with the hydroxyl moiety in the polyol polymer forms a urethane. In this reaction, a chain extender, i.e. an amine, may be used. Where the polyol polymers include one or more (meth)acrylate moieties, the reaction of a isocyanate in a di- or polyisocyanate with a hydroxy moiety in the polyol polymers forms a urethane linkage, and the urethanes already include a (meth)acrylate functionality. Where the polyol polymers do not include one or more (meth)acrylate moieties, one or more of the isocyanate moieties can be reacted with a compound that includes a hydroxy moiety and a (meth)acrylate moiety, such as a hydroxy acrylate, so that the urethane molecule includes one or more (meth)acrylate moieties.

The isocyanate compounds used for preparing the urethane acrylates can be selected from the compounds having a linear saturated hydrocarbon, cyclic saturated hydrocarbon, or aromatic hydrocarbon structure. Such isocyanate compounds can be used either individually or in combinations of two or more. The number of isocyanate moieties in a molecule is usually from 1 to 6, and preferably from 1 to 3.

Polyurethanes produced from aromatic isocyanates tend to turn yellowish over time, albeit without a significant loss in mechanical properties. For this reason, in coating applications, it may be desirable to use aliphatic isocyanates. The most widely used aliphatic diisocyanates are 1,6-hexane dilsocyanate (HDI), isophorone diisocyanate (IPDI), dicyclohexane diisocyanate (HMDI) also known as hydrogenated MDI, and meta-tetramethylxylene diisocyanate (TMXDI). Additional nonaromatic isocyanates include 1,6,11-undecane triisocyanate, lysine-ethylester triisocyanate, transcyclohexane diisocyanate, and tetramethylxylylene diisocyanate. Toluene diisocyanate and xylylene diisocyanate are examples of aromatic isocyanates.

Representative examples of commercially available polyisocyanate compounds include, but are not limited to, A-1310 and Y-5187 manufactured by Nippon Unicar Co., Ltd.; Calenz MOI manufactured by Showa Denko Co., Ltd.; TDI-80/20, TDI-100, MDI-CR100, MDI-CR300, MDI-PH, and NDI manufactured by Mitsui-Xisso Urethane Co., Ltd.; Coronate T, Millionate MT, Millionate MR, and HDI manufactured by Nippon Polyurethane Industry Co., Ltd.; and Takenate 600 manufactured by Takeda Chemical Industries Co., Ltd.

IV. Coating Compositions Including the Polyol Polymers and/or Urethane Acrylates Prepared from the Polyol Polymers

The polyol polymers, acrylated polyol polymers and/or urethanes and urethane acrylates prepared from the polyol polymers and acrylated polyol polymers described herein can be used in coating compositions. The coating compositions can also include reactive diluents, photoinitiators, flatting agents, and other components commonly used in coating compositions. The coating compositions can be water-based, organic solvent-based, or 100% solids coating compositions.

A. Reactive Diluents

The polyol polymers, particularly acrylate polyol polymers, and urethanes and urethane acrylates prepared from the polyol polymers and acrylated polyol polymers, can be combined with suitable reactive diluents to form UV-curable 100 percent solids coating compositions. The reactive diluent(s) are typically low molecular weight (i.e., less than 1000 g/mol), liquid (meth)acrylate-functional compounds. Examples include, but are not limited to: tridecyl acrylate, 1,6-hexanediol diacrylate, 1,4-butanediol diacrylate, ethylene glycol diacrylate, diethylene glycol diacrylate, tetraethylene glycol diacrylate, tripropylene glycol diacrylate and ethoxylated derivatives thereof, neopentyl glycol diacrylate, 1,4-butanediol dimethacrylate, poly(butanediol) diacrylate, tetrathylene glycol dimethacrylate, 1,3-butylene glycol diacrylate, tetraethylene glycol diacrylate, triisopropylene glycol diacrylate, triisopropylene glycol diacrylate, and ethoxylated bisphenol-A diacrylate. Another example of a reactive diluent is N-vinyl caprolactam (International Specialty Products). Further examples are the commercially available products from Sartomer, SR 489, a tridecyl acrylate and SR 506, an isobornyl acrylate.

B. Flatting Agents

Flatting agents are well known to those of skill in the art, and are used to minimize the gloss levels of coatings. Representative flatting agents include, but are not limited to, silica, nylon, and alumina flatting agents.

C. Photoinitiators

The compositions can also include a sufficient amount of a free-radical photoinitiator such that the compositions can be UV-cured. Typically, the concentration of photoinitiator is between 1 and 10% by weight, although weight ranges outside of this range can be used. Alternatively, the compositions can be cured using electron beam (EB) curing.

Any compounds that decompose upon exposure to radioactive rays and initiate the polymerization can be used as the photoinitiator in UV-curable compositions including the polyols, acrylated polyols and/or urethane acrylates prepared from the polyols or acrylated polyols. Photosensitizers can be added as desired. The words “radiation” as used in the present invention include infrared rays, visible rays, ultraviolet rays, deep ultraviolet rays, X-rays, electron beams, alpha-rays, beta-rays, gamma-rays, and the like. Representative examples of the photoinitiators include, but are not limited to, acetophenone, acetophenone benzyl ketal, anthraquinone, 1-hydroxycyclohexylphenyl ketone, 2,2-dimethoxy-2-phenylacetophenone, xanthone compounds, triphenylamine, carbazole, 3-methylacetophenone, 4-chlorobenzophenone, 4,4′-dimethoxybenzophenone, 4,4′-diaminobenzophenone, 2-hydroxy-2-methyl-1-phenylpropan-1-one, 1-(4-isopropylphenyl)-2-hydroxy-2-methylpropan-1-one, xanthone, 1,1-dimethoxydeoxybenzoin, 3,3′-dimethyl-4-methoxybenzophenone, thioxanethone compounds, diethylthioxanthone, 2-isopropylthioxanthone, 2-chlorothioxanthone, 1-(4-dodecylphenyl)-2-hydroxy-2-methylpropan-1-one, 2-methyl-1-[4-(methylthio)phenyl]-2-morpholino-propan-1-one, triphenylamine, 2,4,6-trimethylbenzoyldiphenylphosphineoxide, bis-(2,6-dimethoxybenzoyl)-2,4,4-trimethylpentylphosphine oxide, bisacylphosphineoxide, benzyl dimethyl ketal, fluorenone, fluorene, benzaldehyde, benzoin ethyl ether, benzoin propyl ether, benzophenone, Michler's ketone, 2-benzyl-2-dimethylamino-1-(4-morpholinophenyl)-butan-1-one, 3-methylacetophenone, and 3,3′,4,4′-tetra(t-butylperoxycarbonyl)benzophenone (BTTB). Commercially available photoinitiators include, but are not limited to, Irgacure® 184, 651, 500, 907, 369, 784 and 2959 (manufactured by Ciba Specialty Chemicals Co., Ltd.), Lucirine TPO (manufactured by BASF), Darocur® 1116 and 1173 (manufactured by Ciba Specialty Chemicals Co., Ltd.), Lucirine TPO (manufactured by BASF), Ubecryl® P36 (manufactured by UCB), and Escacure® KIP150, KIP100F (manufactured by Lamberti).

Representative examples of photosensitizers include, but are not limited to, triethylamine, diethylamine, N-methyldiethanolamine, ethanolamine, 4-dimethylaminobenzoic acid, methyl 4-dimethylaminobenzoate, ethyl 4-dimethylaminobenzoate, and isoamyl 4-dimethylaminobenzoate, as well as commercially available products such as Ubecryl® P102, 103, 104, 105 (manufactured by UCB), and the like.

The photoinitiators are typically present in the range of from 0.01 to 10 wt %, although amounts outside this range can be used. Thermal initiators, such as AIBN and di-t-butyl peroxide can be used in place of or in addition to the photoinitiators.

The coating compositions can be used to coat surface coverings, such as floor, wall and ceiling coverings. The coating compositions can be applied to surface coverings using any application method suitable for use with urethane acrylate coating compositions. Such methods include roll coating, spray coating, dip coating and the like. Such coatings are essentially free of acidic and/or heavy metal catalyst residues, and as such, are more stable than coatings including such residues.

The resulting coated products can be tested for improved stability, including stability to both heat and light. Standard ASTM method F1514-98 can be used, advantageously with minor modifications. The standard ASTM method calls for evaluating the material at 158° F. for 7 days and comparing color differences. Advantageously, this test is extended to 6 weeks, with results being determined at every week interval.

Light stability testing can be evaluated using ASTM F1515, advantageously with minor modifications. The standard ASTM method involves exposing the material to a Xenon light source and reporting any differences in color readings at 100, 200, 300 and 400 hours. Advantageously, this test is extended to 500 and 600 hrs.

Improvements in stability can be evaluated by making identical compositions wherein the only difference in the composition is the catalyst used to make the polyol polymer or acrylated polyol polymer materials. That is, one sample can be prepared via enzymatic catalysis, and the second sample prepared via conventional acid or metal-based catalysis.

V. Articles of Manufacture Prepared Using the Polyols and Acrylated Polyols and/or Urethanes and Urethane Acrylates Prepared from the Polyols

The polyol polymers, acrylated polyol polymers, urethanes, and/or urethane acrylates can be used to prepare any article of manufacture commonly made using these components. They can be present in plastics used in food packaging, such as food containers and films used to wrap food products, children's toys, medical and biomedical implants, and the like. In one embodiment, the compounds and/or compositions including the compounds are added to a mold and polymerized to form a desired article of manufacture.

The present invention will be better understood with reference to the following non-limiting examples.

### EXAMPLE 1

### Preparation of a Hydroxyl-terminated Polyester Triol

One hundred forty-eight grams of epsilon-caprolactone, 26 grams of trimethylolpropane and 3 grams porcine pancrease lipase (type II) were charged into 250 ml glass reaction vessel fitted with a mechanical stirrer, condenser, thermometer and dry air inlet and outlet tubes. The mixture was stirred and heated to 70° C. with blanketed dry air at 0.10 SCFH. The reaction mixture was stirred at 70° C. Gas chromatography analysis was used to monitor epsilon-caprolactone conversion. After 4 hours of reaction time, the epsilon-caprolactone conversion was 98.5% complete. After 6 hours, the reaction was 98.7% complete. The reaction mixture was then cooled down to room temperature. The final product was collected by filtering off the enzyme catalyst.

### EXAMPLE 2

### Preparation of Unsaturated Polyols

Six hundred twenty-six grams of epsilon-caprolactone, 318 grams of 2-hydroxyethyl acrylate, 0.68 grams monomethyl ether hydroquinone (p-methoxyphenol) and 9 grams Novozyme-435 were charged into 1 L glass reaction vessel fitted with a mechanical stirrer, condenser, thermometer and dry air inlet and outlet tubes. The mixture was stirred and heated to 70° C. with blanketed dry air (0.10 SCFH). The reaction mixture was stirred at 70° C. Gas chromatography analysis was used to monitor epsilon-caprolactone conversion. After 4 hours, the epsilon-caprolactone conversion was 99.6% complete. After 6 hours, there was no change in the amount of conversion. The reaction mixture was then cooled down to room temperature. The final product was collected by filtering off the enzyme catalyst.

### EXAMPLE 3

### Preparation of Multi-functional Unsaturated Polyols

One hundred twenty four grams of epsilon-caprolactone, 62 grams trimethylolpropane diallyl ether, 0.14 grams monomethyl ether hydroquinone (p-methoxyphenol) and 2 grams Novozyme-435 were charged into 250 ml glass reaction vessel fitted with a mechanical stirrer, condenser, thermometer and dry air inlet and outlet tubes. The mixture was stirred and heated to 70° C. with blanketed dry air (0.10 SCFH). The reaction mixture was stirred at 70° C. Gas chromatography analysis was used to monitor epsilon-caprolactone conversion. After 4 hours, the epsilon-caprolactone conversion was 98% complete. There was no change after 6 hours. The reaction mixture was then cooled down to room temperature. The final product was collected by filtering off the enzyme catalyst.

### EXAMPLE 4

### Preparation of Acrylated Polyester Polyol

Two hundred sixty-seven grams of a hydroxy-terminated polyester (a polymer prepared from composition containing 59.3% by weight of 1,6 hexanediol, 15.6% phthalic anhydride, and 25.1% trimellitic anhydride, where the acid number is less than 5), 92 grams of acrylic acid, 0.04 grams monomethyl ether hydroquinone (p-methoxyphenol), 0.04 grams hydroquinone, 36 grams Novozyme-435 and 65 ml heptane were charged into 1000 ml glass reaction vessel fitted with a mechanical stirrer, D-S trap and water condenser connected to a vacuum system, thermometer and dry air inlet. The mixture was stirred and heated to 90° C. with blanketed dry air at 0.10 SCFH. Then, the dry airflow was stopped and vacuum was gradually applied to initiate boiling. The boiling was adjusted to maximum and the aqueous layer formed in phase separation was removed. Additional heptane was added as needed due to heptane loss. After 6 hours, the final product was recovered by vacuum stripping off the solvent and excess acrylic acid, and filtering off the enzyme catalyst. The product, acrylated polyester polyol, had a hydroxy number of 88.

### EXAMPLE 5

### Coating Formulation

Polycaprolactone triols, unsaturated polyol and acrylated polyester polyol obtained from Examples 1, 2 & 4 were formulated into a dual (thermal/UV) cure coating. See formulation in Table 1. The coating was coated on a vinyl floor, thermally cured at 190° C. for 2 minutes, then UV-cured at 2 J/cm². The final coating had very good stain resistance and abrasion resistance without containing any metal residue.

TABLE 1

| | | |
|---|---|---|
| Acrylated polyester polyol | 70.00 | gr |
| (Example 4) | | |
| Unsaturated polyol (Example 2) | 15.00 | gr |
| Polyester polyol (Example 1) | 15.00 | gr |
| 2-hydroxyethyl acrylate | 15.00 | gr |
| Resimene ® CE-7103 | 51.87 | gr |
| DC-57 | 0.50 | gr |
| Beuzophenone | 3.01 | gr |
| KIP-100F | 2.01 | gr |
| Nacure ® XP-357 | 6.69 | gr |

Having disclosed the subject matter of the present invention, it should be apparent that many modifications, substitutions and variations of the present invention are possible in light thereof. It is to be understood that the present invention can be practiced other than as specifically described. Such modifications, substitutions and variations are intended to be within the scope of the present application.

1. A polyol polymer composition comprising:
a) a polyol polymer comprising a plurality of moieties derived from a compound selected from the group consisting of a lactone, a lactide, a glycolide, and combinations thereof, wherein at least one of the plurality of moieties is covalently linked via an ester linkage to the hydroxy moiety of a hydroxy moiety-containing polymerization initiator, and
b) an enzyme catalyst.

2. A polyol polymer composition comprising a polyol polymer comprising a plurality of moieties derived from a compound selected from the group consisting of a lactone, a lactide a glycolide, and combinations thereof, wherein at least one of the plurality of moieties is covalently linked via an ester linkage to the hydroxy moiety of a hydroxy moiety-containing polymerization initiator,
wherein the composition is essentially free of acidic catalyst residues and heavy metal catalyst residues.

3. The polyol polymer composition according to claim 1, wherein the enzyme catalyst comprises a lipase enzyme.

4. A polyol polymer composition according to claims 1 or 2, wherein the polyol polymer comprises at least two ends, at least one end of which is capped with a (meth)acrylate moiety.

5. A polyol polymer composition according to claims 1 or 2, wherein the hydroxy moiety-containing polymerization initiator is a compound of the formula (R¹)ₐR(OH)_{b},
wherein a+b≧2 and b is at least 1,
R¹ is a double bond-containing moiety, and
R is selected from the group consisting of optionally substituted alkyl, aryl, aralkyl, alkaryl, ether and ester moieties, and a polymer comprising at least one hydroxy moiety, wherein the optional substituent is selected from the group consisting of halo, thio, nitrile, nitro, ester, ether, amide, ketone, acetal, silyl, phosphorous, and combinations thereof.

6. A polyol polymer composition according to claims 1 or 2, wherein the hydroxy moiety-containing polymerization initiator is selected from the group consisting of 2-hydroxyethyl acrylate, 2-hydroxypropyl acrylate, pentaerythritol triacrylate, dipentaerythritol pentacrylate, and combinations thereof.

7. A polyol polymer composition according to claims 1 or 2, wherein the lactone is selected from the group consisting of caprolactone and valerolactone.

8. A (meth)acrylated polyol polymer composition comprising:
a) a polyol polymer comprising:
i) a plurality of moieties derived from a compound selected from the group consisting of a lactone, a lactide, a glycolide, and combinations thereof, wherein at least one of the plurality of moieties is covalently linked via an ester linkage to the hydroxy moiety of a hydroxy moiety-containing polymerization initiator, and
ii) at least one ester moiety derived from a hydroxy moiety on the polyol polymer and (meth)acrylic acid, and
b) an enzyme catalyst.

9. A (meth)acrylated polyol polymer composition comprising a polyol polymer that comprises:
a) a plurality of moieties derived from a compound selected from the group consisting of a lactone, a lactide, a glycolide, and combinations thereof, wherein at least one of the plurality of moieties is covalently linked via an ester linkage to the hydroxy moiety of a hydroxy moiety-containing polymerization initiator, and
b) at least one ester moiety derived from a hydroxy moiety on the polyol polymer and (meth)acrylic acid,
wherein the composition is essentially free of acidic catalyst residues and heavy metal catalyst residues.

10. The (meth)acrylated polyol polymer composition according to claim 8, wherein the enzyme catalyst comprises a lipase enzyme.

11. A (meth)acrylated polyol polymer composition according to claims 8 or 9, wherein the hydroxy moiety-containing polymerization initiator comprises a (meth)acrylate moiety.

12. A (meth)acrylated polyol polymer composition according to claims 8 or 9, wherein the hydroxy moiety-containing polymerization initiator is a compound of the formula (R¹)ₐR(OH)_{b},
wherein a+b≧2 and b is at least 1,
R¹ is a double bond-containing moiety, and
R is selected from the group consisting of optionally substituted alkyl, aryl, aralkyl, alkaryl, ether and ester moieties, and a polymer comprising at least one hydroxy moiety, wherein the optional substituent is selected from the group consisting of halo, thio, nitrile, nitro, ester, ether, amide, ketone, acetal, silyl, phosphorous, and combinations thereof.

13. A (meth)acrylated polyol polymer composition according to claims 8 or 9, wherein the hydroxy moiety-containing polymerization initiator is selected from the group consisting of 2-hydroxyethyl acrylate, 2-hydroxypropyl acrylate, pentaerythritol triacrylate, dipentaerythritol pentacrylate, and combinations thereof.

14. A (meth)acrylated polyol polymer composition according to claims 8 or 9, wherein the lactone is selected from the group consisting of caprolactone and valerolactone.

15. A polyol polymer composition comprising:
a) a linear or branched polyol polymer, and
b) an enzyme catalyst.

16. The polyol polymer composition of claim 15, wherein the polyol polymer is a polyol oligomer.

17. The polyol polymer composition of claim 15, wherein the polyol polymer comprises ethylenic unsaturation in the form of a moiety selected from the group consisting of a (meth)acrylate moiety, an allyl moiety, a vinyl moiety, a vinylidine moiety, a vinyl ether moiety, and an alkynyl moiety.

18. The polyol polymer composition of claim 15, wherein the polyol polymer is selected from the group consisting of a polyester polyol, a polyether polyol, and combinations thereof.

19. The polyol polymer composition of claim 15, wherein the enzyme catalyst comprises a lipase.

20. The polyol polymer composition of claim 15, wherein the composition is essentially free of acidic or heavy metal catalyst residues.

21. The polyol polymer composition of claim 15, wherein the polymer is prepared by esterification of polyfunctional carboxylic acids and polyfunctional hydroxy-containing materials, wherein the esterification is catalyzed by enzymatic catalysis.

22. The polyol polymer composition of claim 21, wherein the enzyme catalyst comprises a lipase.

23. A composition comprising a compound selected from the group consisting of a urethane monomer, a urethane polymer, and combinations thereof,
wherein the urethane moiety comprises urethane linkages formed from at least one hydroxy moiety on a polyol polymer prepared via a reaction selected from the group consisting of enzyme-catalyzed esterification and enzyme-catalyzed ring-opening transesterification with at least one isocyanate moiety on a polyisocyanate.

24. The composition of claim 23, wherein the urethane polymer is a urethane oligomer.

25. The composition of claim 23, wherein the polyol polymer comprises a plurality of moieties derived from a compound selected from the group consisting of a lactone, a lactide, a glycolide, and combinations thereof, wherein at least one of the plurality of moieties is covalently linked via an ester linkage to the hydroxy moiety of a hydroxy moiety-containing polymerization initiator.

26. The composition of claim 23, wherein the polymerization initiator comprises ethylenic unsaturation.

27. The composition of claim 26, wherein the ethylenic unsaturation is present in a moiety selected from the group consisting of a (meth)acrylate moiety, an allyl moiety, a vinyl moiety, a vinylidine moiety, a vinyl ether moiety, and an alkynyl moiety.

28. The composition of claim 25, wherein the hydroxy moiety-containing polymerization initiator is selected from the group consisting of 2-hydroxyethyl acrylate, 2-hydroxypropyl acrylate, pentaerythritol triacrylate, dipentaerythritol pentacrylate, and combinations thereof.

29. The composition of claim 25, wherein the lactone is selected from the group consisting of caprolactone and valerolactone.

30. A composition as in any one of claims 1, 2, 8, 9, 15, or 23, wherein the composition further comprises a reactive diluent.

31. A composition as in any one of claims 1, 2, 8, 9, 15 or 23, wherein the composition further comprises a flatting agent.

32. A composition as in any one of claims 1, 2, 8, 9, 15 or 23, wherein the composition further comprises a photoinitiator.

33. A surface covering coated with the composition as in any one of claims 1, 2, 8, 9, 15, or 23.

34. The surface covering of claim 33, wherein the surface covering is a floor covering.

35. A method for forming a polyol polymer, comprising the step of ring-opening polymerization of a compound selected from the group consisting of a lactone, a lactide, a glycolide, and combinations thereof, the ring opening being initiated by a hydroxy moiety-containing polymerization initiator, wherein the ring-opening polymerization reaction is catalyzed by an enzymatic catalyst.

36. The method of claim 35, wherein the enzymatic catalyst comprises a lipase.

37. The method of claim 35, wherein the hydroxy moiety-containing polymerization initiator comprises a (meth)acrylate moiety.

38. The method of claim 35, wherein the hydroxy moiety-containing polymerization initiator comprises a compound of the formula (R¹)ₐR(OH)_{b},
wherein a+b>2 and b is at least 1,
R¹ is a double bond-containing moiety, and
R is selected from the group consisting of an optionally substituted alkyl, aryl, aralkyl, alkaryl, ether and ester moieties, and a polymer comprising at least one hydroxy moiety, wherein the optional substituent is selected from the group consisting of halo, thio, nitrile, nitro, ester, ether, amide, ketone, acetal, silyl, phosphorous, and combinations thereof.

39. The method of claim 35, wherein the hydroxy moiety-containing polymerization initiator is selected from the group consisting of 2-hydroxyethyl acrylate, 2-hydroxypropyl acrylate, pentaerythritol triacrylate, dipentaerythritol pentacrylate, and combinations thereof.

40. The method of claim 35, wherein the lactone is selected from the group consisting of caprolactone and valerolactone.

41. The method of claim 35, wherein the polyol polymer comprises at least two ends, and wherein the method further comprises the step of capping at least one of the ends with a (meth)acrylate moiety.

42. The method of claim 41, wherein the capping step is catalyzed with an enzymatic catalyst.

43. The method of claim 42, wherein the enzyme catalyst for the capping step comprises a lipase.

44. A method for forming a (meth)acrylated polyol polymer, comprising capping at least one of end of a polyol polymer with a (meth)acrylate moiety, the end capping being catalyzed by an enzymatic catalyst.

45. The method of claim 43, wherein the enzymatic catalyst comprises a lipase.

46. A method for forming a polyester polyol, comprising the esterification of an acid selected from the group consisting of dibasic carboxylic acid, polybasic carboxylic acid, and combinations thereof with a compound including at least two hydroxy moieties, wherein the esterification is catalyzed by an enzymatic catalyst.

47. The method of claim 46, wherein the enzyme catalyst comprises a lipase.

48. The method of claim 46, wherein the polyester polyol comprises at least two ends, and wherein the method further comprises the step of capping at least one of the ends with a (meth)acrylate moiety.

49. The method of claim 48, wherein the capping step is catalyzed by an enzyme catalyst.

50. The method of claim 49, wherein the enzyme catalyst for the capping step comprises a lipase.

51. The method of claim 46, wherein the compound including at least two hydroxy moieties further comprises a double bond-containing moiety.

52. A method for forming a urethane acrylate, comprising reacting a polyol polymer with a polyisocyanate comprising:
a) preparing a polyol polymer comprising at least one (meth)acrylate moiety by a ring-opening polymerization of a compound selected from the group consisting of a lactone, a lactide, a glycolide, and combinations thereof, the ring opening being initiated by a hydroxy moiety-containing polymerization initiator, wherein the ring opening polymerization is catalyzed by an enzymatic catalyst; and
b) reacting at least one isocyanate moiety on a polyisocyanate with a hydroxy moiety on the polyol polymer.

53. The method of claim 52, wherein the enzymatic catalyst comprises a lipase.

54. The method of claim 52, wherein the hydroxy moiety-containing polymerization initiator comprises a (meth)acrylate moiety.

55. The method of claim 52, wherein the hydroxy moiety-containing polymerization initiator is a compound of the formula (R¹)ₐR(OH)_{b},
wherein a+b≧2 and b is at least 1,
R¹ is a double bond-containing moiety, and
R is selected from the group consisting of an optionally substituted alkyl, aryl, aralkyl, alkaryl, ether and ester moieties, and a polymer comprising at least one hydroxy moiety, wherein the optional substituent is selected from the group consisting of halo, thio, nitrile, nitro, ester, ether, amide, ketone, acetal, silyl, phosphorous and combinations thereof.

56. The method of claim 52, wherein the hydroxy moiety-containing polymerization initiator is selected from the group consisting of 2-hydroxyethyl acrylate, 2-hydroxypropyl acrylate, pentaerythritol triacrylate, dipentaerythritol pentacrylate, and combinations thereof.

57. The method of claim 52, wherein the lactone is selected from the group consisting of caprolactone and valerolactone.

58. A coating composition comprising a (meth)acrylated polyol polymer, wherein the polyol polymer is prepared by a method comprising a step selected from the group consisting of:
(a) forming a polyol polymer by ring-opening polymerization of a compound selected from the group consisting of a lactone, a lactide, a glycolide, and combinations thereof, the ring opening being initiated by a hydroxy moiety-containing polymerization initiator, wherein the ring-opening polymerization reaction is catalyzed by an enzymatic catalyst,
(b) forming a polyol polymer by esterification of polyfunctional carboxylic acids and polyfunctional hydroxy-containing materials, wherein the esterification is catalyzed by an enzymatic catalyst,
(c) capping at least one of the end of a polyol polymer with a (meth)acrylate moiety, wherein the end capping reaction is catalyzed by an enzymatic catalyst,
(d) the combination of steps (a) and (c), and
(e) the combination of steps (b) and (c).

59. The coating composition of claim 58, wherein the coating composition has improved heat stability when compared to a coating composition comprising a comparable (meth)acrylated polyol prepared using a catalyst selected from the group consisting of a strong acid catalyst and a metallic catalyst.

60. The coating composition of claim 58, wherein the coating composition has improved light stability when compared to a coating composition comprising a comparable (meth)acrylated polyol prepared using a catalyst selected from the group consisting of a strong acid catalyst and a metallic catalyst.

61. The coating composition of claim 58, wherein the coating composition has improved color stability when compared to a coating composition comprising a comparable (meth)acrylated polyol prepared using a catalyst selected from the group consisting of a strong acid catalyst and a metallic catalyst.

62. The coating composition of claim 58, wherein the coating composition has improved hydrolysis stability when compared to a coating composition comprising a comparable (meth)acrylated polyol prepared using a catalyst selected from the group consisting of a strong acid catalyst and a metallic catalyst.
